(19) United States
(12) Patent Application Publication
(10) Pub. No.: US 2012/0123876 A1
(43) Pub. Date: May 17, 2012

(54) RECOMMENDING AND PRESENTING ADVERTISEMENTS ON DISPLAY PAGES OVER NETWORKS OF COMMUNICATION DEVICES AND COMPUTERS

(76) Inventors: Sreenivasa Prasad Sista, Bangalor (IN); Sridhar Ranganathan, Bangalor (IN); Karthik Mahadevan, Bangalor (IN)

(21) Appl. No.: 12/948,319

(22) Filed: Nov. 17, 2010

(51) Int. Cl. G06Q 30/00

(52) U.S. Cl. 705/14.73

(57) ABSTRACT

An aspect of the present invention recommends and presents ads of interest to a user requesting display pages by maintaining a Click Through Rate (CTR) matrix containing terms extracted from prior display page request URLs and associated parameters as the row index and corresponding terms extracted from ad URLs, ad text and associated terms of ads presented in response to those display page requests as the column index with the CTR value as the elements, broadly matching current display page request to one of the CTR rows, retrieving the ad vectors and their CTR values for the matched row, computing an ad score for selected ad vectors and providing one or more ads chosen based on the ad scores along with the requested display pages.

### BACKGROUND OF THE INVENTION

1. Field of the Invention

The present disclosure relates generally to networks, and more specifically to recommending and presenting advertisements on display pages over networks of communication devices and computers.

2. Description of the Prior Art

A network of computers provides connectivity between the constituents of the network. The worldwide network of computers commonly referred to as the Internet is an example of such a network. There are communication devices such as mobile phones, PDAs, etc. which are part of mobile phone networks. Such devices also may connect to networks of computers such as the Internet, over the mobile phone networks. The users of the computers and the communication devices accesses information from other computers, servers, etc. using applications such as web browsers, Apple app-store applications, etc. Information presented to users by such applications is referred to as a display page (for example, web pages, games from app-stores, etc.) in this document.

Display pages are a fast growing medium for advertising. The success of any advertisement lies in getting the user interested (persuading the user to peruse the advertisement), and converting the interest into a sale. The chances of success improve, if the kind of goods or services that would interest the user is known or could be predicted. Therefore, it is desirable that the kind of goods or services, whose advertisements could interest the user be predicted and based on the prediction, appropriate advertisements be recommended and presented to the user.

### SUMMARY OF THE INVENTION

In view of the foregoing disadvantages inherent in the known types of advertisement display systems now present in the prior art, the present invention provides an improved advertisement recommending and displaying method over networks of communication devices, and overcomes the above-mentioned disadvantages and drawbacks of the prior art. As such, the general purpose of the present invention, which will be described subsequently in greater detail, is to provide a new and improved advertisement recommending and displaying method over networks of communication devices and method which has all the advantages of the prior art mentioned heretofore and many novel features that result in a advertisement recommending and displaying method over networks of communication devices which is not anticipated, rendered obvious, suggested, or even implied by the prior art, either alone or in any combination thereof.

To attain this, the present invention essentially comprises a method of recommending and presenting advertisements with display pages over networks of communication devices and computers. The method uses the steps of receiving a display page request from a user, and creating a request vector comprising a set of terms extracted from a URL of the display page request as well as terms from other information associated with the display page request. Then matching the request vector to a row in a Click Through Rate (CTR) matrix, and selecting ad vectors from the matched row and retrieving the CTR of the selected ad vectors from the CTR matrix. The method then includes computing ad scores for the selected ad vectors, and choosing one or more ad vectors from the selected ad vectors. Lastly, presenting to the user one or more ads corresponding to the one or more chosen ad vectors along with the requested display pages.

An aspect of the present invention recommends advertisements of potential interest to a user requesting display pages by predicting those ads that could be of interest from several advertisements and selecting one more ads from the predicted ads. Ads chosen from the selected ads may be presented to the user along with the requested display page.

In an embodiment, a request vector is created with a set of terms occurring in a URL of a display page request as well as terms from other information such as time of request, country, mobile network operator and hand set parameters associated with the display page request. The request vector is broadly matched to a row in a Click Through Rate (CTR) matrix. The CTR of the ad vectors from the matched row are retrieved, an ad score is computed for them and a number of ads with the highest ad score are selected. One or more ads are chosen from the selected ads are presented to the user along with the requested display pages.

Another aspect of the present invention obtains the broad match through a dot product between the request vector and a row index of the CTR matrix.

Yet another aspect of the present invention computes the ad score as a weighted average of the CTR value and factors such as ad conversion rate, Cost Per Click (CPC), Cost Per Acquisition (CPA), ad budget and business rules.

In one embodiment, the CTR matrix is created by generating a page vector for all the display page requests, retrieving all ad vectors corresponding to the said page vector, computing the CTR value for the retrieved ad vectors, inserting the computed values into the CTR matrix; estimating the CTR value for the elements of the CTR matrix with no value, and storing the CTR matrix.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved advertisement recommending and displaying method over networks of communication devices that has all of the advantages of the prior art and none of the disadvantages.

Still another object of the present invention is to provide a new advertisement recommending and displaying method over networks of communication devices that provides in the apparatuses and methods of the prior art some of the advantages thereof, while simultaneously overcoming some of the disadvantages normally associated therewith.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### BRIEF DESCRIPTION OF THE DRAWINGS

Example embodiments will be described with reference to the following accompanying drawings, which are described briefly below.

FIG. 1 is an example environment in which several aspects of the present invention may be implemented.

FIG. 2 is a flowchart illustrating the manner in which ads of potential interest to a user are recommended and presented in an embodiment.

FIG. 3 is a flowchart illustrating the manner in which the CTR matrix is generated in an embodiment.

FIG. 4 is a block diagram illustrating a web server for recommending and presenting advertisements with display pages in an embodiment.

In the drawings, like reference numbers generally indicate identical, functionally similar, and/or structurally similar elements. The drawing in which an element first appears is indicated by the leftmost digit(s) in the corresponding reference number.

### DESCRIPTION OF THE PREFERRED EMBODIMENT

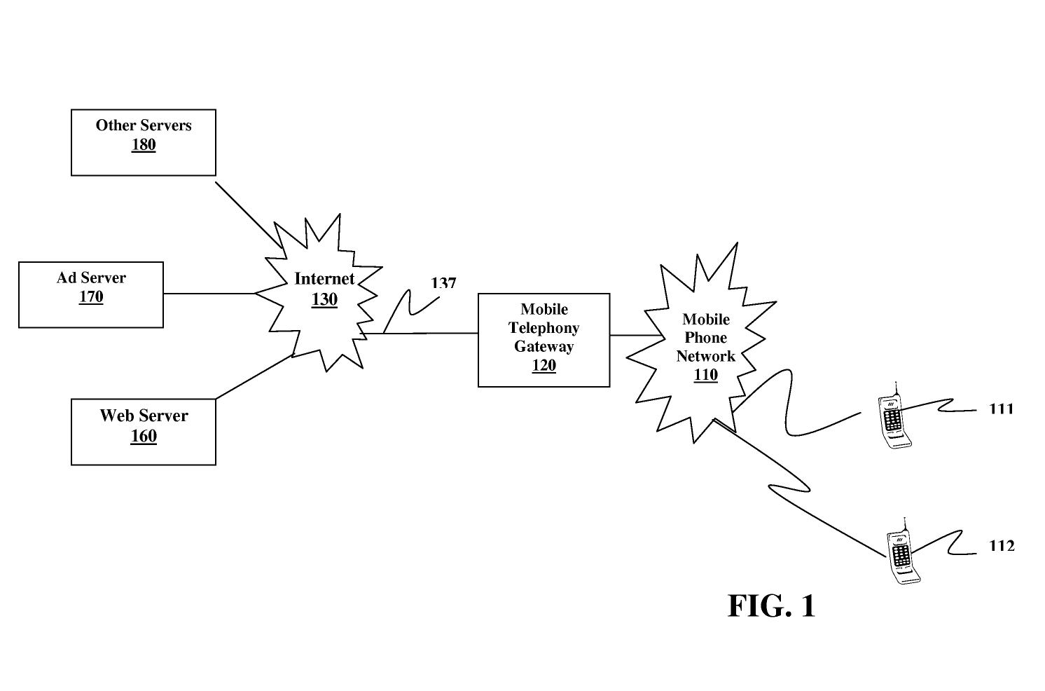

FIG. 1 is a block diagram of an example environment in which several aspects of the present invention may be implemented. The system there is shown containing mobile phone network 110, mobile phones 111 and 112, mobile telephony gateway 120, Internet 130, web server 160, ad server 170 and other servers 180. Each block is described in further detail below.

The block diagram is shown containing only representative systems for illustration. However, real-world environments may contain more/fewer/different systems/components/blocks, both in number and type, depending on the purpose for which the environment is designed, as will be apparent to one skilled in the relevant arts. For example, though the other servers 180 is shown connected to Internet 130, it may be a part of the mobile phone network 110. Similarly, only a single web server 160 is shown, though many such web servers may be present. Though web servers are shown to provide the display pages in this document, in other environments, the display pages may be produced by other servers and applications (for e.g. by a game such as Scrabble in Apple app-store environment), well known in the arts.

Mobile phone network 110 represents a communication network providing voice and data connectivity between mobile phones 111 and 112, voice and data connectivity between mobile phones (111 and 112) and other telephony networks (such as other mobile networks, PSTN (Public Switched Telephone Network), etc.), as well as data connectivity over Internet 130 to other devices connected to Internet 130 using mobile telephony gateway 120. Mobile phone network 110 may be implemented using technologies such as GSM, CDMA, etc., well known in the relevant arts. Mobile phone 112 is an internet enabled mobile phone.

Mobile telephony gateway 120 represents a system which provides the necessary conversions to facilitate communications between mobile phones 111 and 112 with other telephony networks, as well as access to Internet 130 over path 137. Mobile telephony gateway 120 receives voice, data and signaling information and converts the voice, data and signaling information to a format compatible with protocols of the destination systems. Mobile telephony gateway 120 may be implemented in a known way.

Internet 130 represents a conglomeration of one or more constituent networks providing connectivity between Web server 160, ad server 170, other servers 180 and mobile phone 112 through mobile phone network110 and mobile telephony gateway 120. Internet 130 may be implemented using protocols such as Internet Protocol (IP) well known in the relevant arts, with each of the systems also potentially operating consistent with IP.

Web server 160 executes various applications, which may be accessed from mobile phone 112 (internet enabled mobile phone) using a suitable user interface. For example, web server 160 may generate various display pages, which are sent over Internet 130, mobile telephony gateway 120 and mobile phone network 110 to mobile phone 112 and a user may interact with the applications using a web browser implemented on mobile phone 112.

Ad server 170 executes various applications to store, identify, retrieve and provide advertisements to web server 160.

Other servers 180 represent servers such as a number of data base servers (which generally provides a centralized storage of data such that several other systems, for example, client systems or server systems, can access the data bases), etc. These database servers may provide data for other applications, such as those running on the web server or the ad server. Other servers 180 may also comprise servers which facilitate the functioning of applications such as app-stores (for example, Apple app-stores).

A user of an internet enabled mobile phone such as mobile phone 112 may request content from web server 160 using, for example a web browser. Web server 160 requests ad server 170 for advertisements which are to be provided to the user along with the requested display page. Web server 160 receives the advertisements from ad server 170, places the advertisement(s) on the requested display page and provides the resultant display page (with advertisements) to the user.

According to an aspect of the present invention, a user of mobile phone 112 may request display pages of interest from web server 160. Web server 160 predicts one or more advertisements (ads) which may be of potential interest to the user, retrieves those ads and presents the requested display page along with the ads to the user, as described below. However, the features can be extended to in alternative embodiments, as will be apparent to one skilled in the relevant arts by reading the disclosure provided herein.

### Recommending and Presenting Ads of Potential Interest to a User

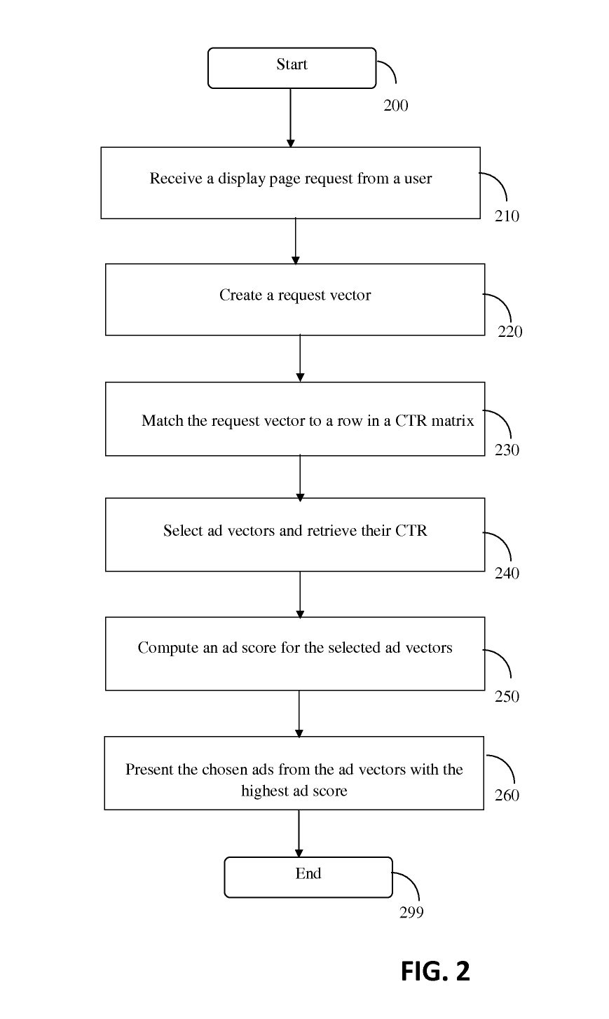

FIG. 2 is a flowchart illustrating the manner in which ads of potential interest to a user are recommended and presented to a user in an embodiment. The flowchart is described with respect to FIG. 1, merely for illustration. However, various features can be implemented in other environments and other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, web server 160 receives a display page request from a user such as a user of mobile phone 112. The user may make the request using a user interface of a suitable application such as a web browser executing in mobile phone 112. The request for display pages may be made using protocols such as http protocol, well known in the arts.

In step 220, web server 160 creates a request vector. The request vector contains a selection of terms occurring in the URL of the display page request as well as terms from other information, as described for page vector in the later sections.

In step 230, web server 160 matches the request vector to a row in a CTR matrix. The CTR matrix has page vectors as the rows and ad vectors (both page vector and ad vector are described in below sections) as the columns, with the elements of the matrix having their value equal to the Click Through Rate (CTR). CTR is the value computed by dividing the number of impressions of an ad for the display page request corresponding to the page vector by the number of times users have clicked on the ad. It may be noted that other metrics such as ad conversion rate, which is the ratio of the number of conversions (the number of times a user performs the intended action of the ad, for e.g. if the ad is for selling a book and the user clicks on the ad and goes on to buy the book) for an ad to the number of impressions of that ad, may be used instead of the CTR in other embodiments. For example, an ad conversion rate matrix with page vectors as column index, ad vectors as row index and the elements having the ad conversion rate as values may be created and used in a manner similar to the CTR matrix.

The request vector is matched approximately or broadly to the rows of the CTR matrix and the closest matching row is chosen. Broad row matching may be achieved in a known manner. In an example, the row matching may be achieved by computing a dot product between the request vector and the row index of the CTR matrix. If the request vector is sparse, a Latent Semantic vector transformation followed by a dot product in the Latent Semantic vector space may be computed. The result of the dot product is a similarity score with a higher similarity score indicating a closer match between the request vector and the corresponding row of the CTR matrix. The row with the highest similarity score with the request vector is chosen.

In step 240, web server 160 selects ad vectors and retrieves their CTR values. After the request vector is matched with a row of the CTR matrix in step 230 above, web server 160 selects some of the ad vectors (for example, by selecting a predetermined number of ad vectors, such as 100 ad vectors of the matched row having the highest CTR values). The CTR values of the selected ad vectors are retrieved from the CTR matrix.

In step 250, web server 160 computes an ad score for the selected ad vectors. In an embodiment, the ad score is computed as a weighted average of the CTR value and other factors such as ad conversion rate, Cost Per Click (CPC), Cost Per Acquisition (CPA), ad budget, business rules, etc. The weights may be assigned according to criteria well known in the arts.

In step 260, web server 160 presents chosen ads from the ads corresponding to the ad vectors with the highest ad scores. For example, two ad vectors may be randomly chosen from the 10 ad vectors with the highest scores, and the ads corresponding to the two chosen ad vectors may be impressed on the display pages. In other embodiments, ad vectors may be chosen using other criteria, for example, to test the quality of the ads. The chosen ad(s) are retrieved from ad server 170 and presented to the user along with the requested display page. The flow chart ends in step 299.

It may be appreciated that the CTR matrix plays a crucial role in the selection of the ad. Accordingly, the description is continued with the manner in which the CTR matrix may be generated in one embodiment.

### Generating the CTR Matrix

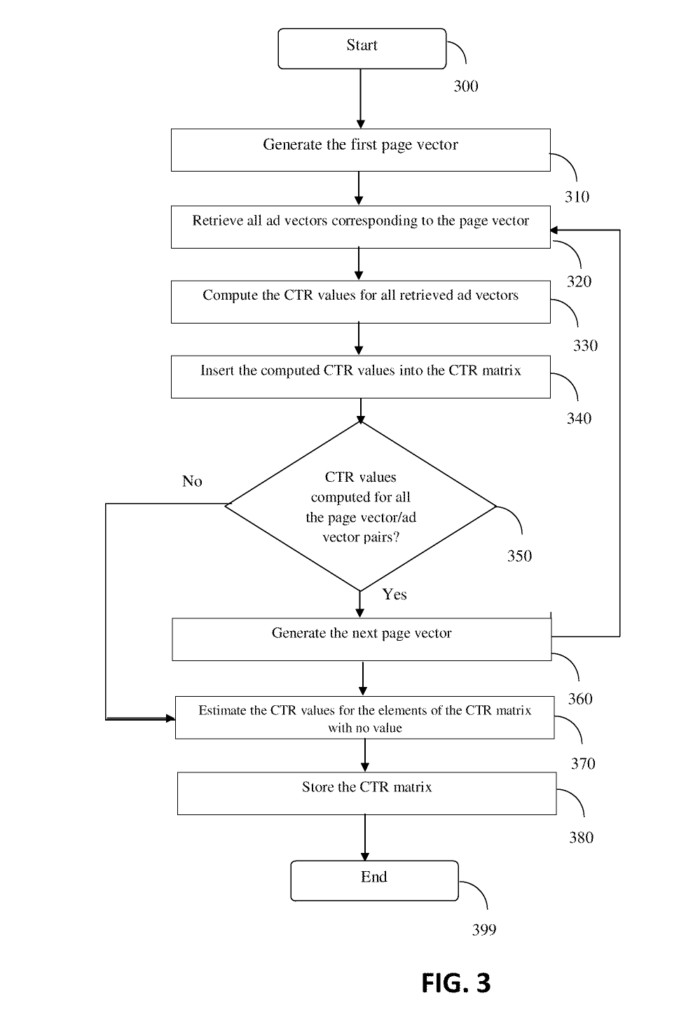

FIG. 3 is a flowchart illustrating the manner in which the CTR matrix may be generated in an embodiment. The flowchart is described with respect to FIGS. 1-3, merely for illustration. However the features can be implemented in other environments and various other servers as well, without departing from the scope and spirit of several aspects of the present invention. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 301, in which control passes immediately to step 310.

In step 310, web server 160 generates the first page vector. The page vector consists of a set of selected terms obtained from the URL of a display page request as well as values such as time of request, country, mobile network operator, hand set parameters, etc, and is obtained as described below.

The URL for a display page request contains path values and key & value parameter pairs. The URL may be parsed to extract terms (words and phrases which may be indicative of the display page content). This set of terms is referred to as term set. For example, a search for the phrase “Fast marginal” on the well known search web site Google (www.google.com) using Chrome web browser of Google leads to a URL http://www.google.com/search?sourceid=chrome&ie=UTF-8&q=Fast+marginal, from which a term set (google, search, source, chrome, UTF-8, fast+marginal) may be extracted.

Similar term sets are extracted for all the available display page requests (Web server 160 may store the URLs of all the display page requests for this purpose). It is necessary to obtain a smaller set of more relevant terms to reduce computational complexity as well as to obtain robust CTR values. Each term in each of the term sets is assigned a score. Thereafter, the overall score for each term over all the available term sets is computed. This overall score may be computed in many ways, such as simply aggregating the scores for each term across all the URLS, or by applying a function such as TF-IDF (Term Frequency-Inverse Document Frequency) score well known in the arts. The overall set of terms may be referred to as the term universe. The smaller set may be obtained by applying a constraint (for example, setting a threshold for the overall score and dropping those terms which have the overall score below the threshold). This smaller universe may be referred to as a tag universe. It may be noted that the tag universe may be updated recursively, that is as more and more display page requests are received by server 160, the above described process may be applied to extract term sets and then re compute the overall score and update the tag universe. The tag universe may be stored, for example in a data base on the other servers 180.

For each of the display page requests, a term set is extracted as described above. In each of these term sets, only those terms which find a place in the tag universe are retained and the remaining terms are dropped, to obtain a tag set for each of the term sets. For the example term set given above, the tag set formed may be (google, search, fast, marginal). Additional terms such as early_morning, india, airtel, nokia, wifi, touch_screen corresponding to time, country, mobile network operator, hand set parameters, etc. may be added to the tag set to obtain a page vector. These additional terms allow the tag set to be partitioned into multiple segments, for example country wise, as the response of the users to ads may vary according to their nationalities. The page vector for all the available display page requests is obtained and may be stored, for example in a database on other servers 180. An example of a page vector is ([google, search, fast, marginal], [early_morning, india, airtel, nokia, wifi, touch_screen])

Ad vectors are obtained in a similar manner. Each of the ads has a URL similar to the URL for the display page request. The terms are extracted to obtain ad term sets in a manner similar to the term sets above. To this are added the terms from the textual part of the ads. These terms are assigned a score and the overall score is computed in a manner described above and the smaller set, referred to in this case as ad tag universe is obtained. The ad tag universe may also be stored, for example in a data base on the other servers 180. For example, for an Ad URL http://m.mymobfun.com/game/my/mkh/pqr the ad term set may be (m, mymobfun, game, my, mkh, pqr, com), and for the corresponding Ad Text “Roll up some fun and join the fight!” the terms from the textual part may be (roll, up, some, fun, join fight). The ad term set from both Ad URL and Ad Text are (m, mymobfun, game, my, mkh, pqr, com, roll, up, some, fun, join fight). Out of many such Ad vectors, if the terms (game, fun, fight) have term score greater than a threshold then these terms will be a part of the Ad tag universe.

An ad tag set is also obtained in a manner similar to the tag set above, by extracting terms from the URL of the ad and dropping terms not in the ad tag universe. From the above example, the ad tag set may be (game, fun, fight). An ad vector may be obtained by adding additional terms such as ad parameters (for example, text/banner ad, adult ad, etc.) to the ad tag set. If the additional terms for the above example are (text_ad, non_adult_ad) then the ad vector obtained may be ([game, fun, fight], [text_ad, non_adult_ad]). The ad vector for all the available ads may be obtained and stored, for example in a database on other servers 180.

In step 320, web server 160 retrieves all ad vectors corresponding to the page vector. If an ad has been shown along with a display page, the ad vector of the ad that has been shown corresponds to the page vector of the display page. Since many ads may be shown (over different requests and time horizons) for a particular display page, there may be many ad vectors corresponding to each page vector, and all those ad vectors are retrieved during this step.

In step 330, web server 160 computes the Click Through Rate (CTR) value for the page vector-retrieved ad vector pair for all retrieved ad vectors. The CTR may be computed as defined in step 230 above.

In step 340, web server 160 inserts the computed CTR values into the CTR matrix. The CTR matrix has the page vector as the row index and the ad vector as the column index, and the value is inserted accordingly for all the retrieved ad vectors.

In step 350, web server 160 checks whether the CTR value has been computed for all the page vector/ad vector pairs. If the CTR has been computed for all the page vector/ad vector pairs, processing continues to step 370. If not, control passes to step 360.

In step 360, web server 160 generates the next page vector and control passes to step 320.

In step 370, web server 160 estimates the CTR values for the elements of the matrix with no value. All the ads may not be shown for all the display pages. Hence, for each display page (and consequently, page vector) there may be some ads which were never shown. Hence the corresponding CTR element in the CTR matrix may have no value.

The CTR value for elements with no value may be estimated using well known techniques. For example, one approach may be to use a function such as the geometric mean of the average of the CTR values of non-zero elements in the row, and the average of the CTR values of non-zero elements in the column, of the element whose value is to be estimated. Another approach may be use to use one of the many well known smoothing techniques, such as matrix dimensionality reduction techniques. Another approach may be to estimate the CTR from similar page-CTR vectors, where the missing CTR element is estimated as a function (e.g., arithmetic mean) of the CTR values from similar page-CTR vectors for the same Ad-vector column. The similarity between the page vectors may be computed in many ways, such as from computing the cosine distance between the page vectors. Yet another approach is to use regression techniques (which may be linear or non linear). The regression technique may examine all the available data in the CTR matrix so that the CTR may be approximated as a function of the page vector and the ad vector, using techniques well known in the arts. Another technique may be to employ collaborative filtering techniques, well known in the arts, with page vector as one dimension and ad vector as the second dimension. From such approximations, the CTR values may be estimated. It may be noted that because CTR values are estimated for those elements which have no computed value, the corresponding ads (which have not been shown on any display pages of interest earlier) may also be recommended for presenting on display pages.

In step 380, web server 160 stores the CTR matrix. The CTR matrix may be stored, for example in a database on other servers 180. The flow chart ends in step 399.

The description is continued with a block diagram of web server 160 in an embodiment.

A Web Server for Recommending and Presenting Advertisements with Display Pages Over Networks

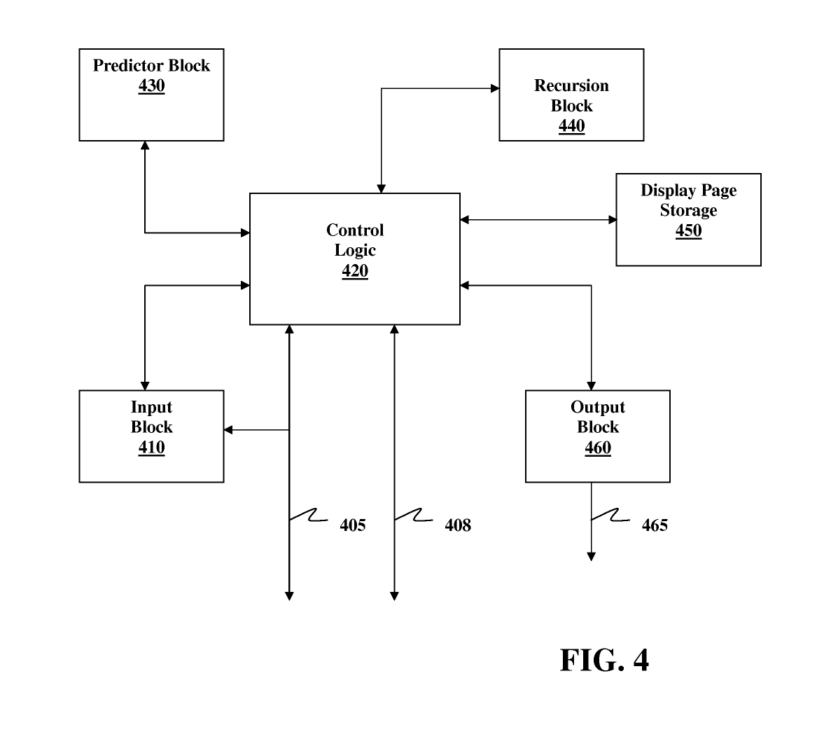

FIG. 4 is a block diagram illustrating a web server for recommending and presenting advertisements with display pages over networks of communication devices and computers. The web server is shown containing input block 410, control logic 420, predictor block 430, recursion block 440, display page storage 450 and sending block 460. Each block is described in further detail below.

Again, merely for illustration, only representative number/type of blocks are shown in FIG. 2. However, web server 160 according to several aspects of the present invention can contain many more/fewer/different blocks, both in number and type, depending on the purpose for which the environment is designed, as will be apparent to one skilled in the relevant arts. For example, though display page storage 450 is shown as part of the web server, display pages may be stored in one or more separate storages.

Input block 410 receives requests for display pages from user interfaces such as web browser(s) on mobile phone 112, over path 405. The requests may use protocols such as the HTTP protocol and contains the URL of the requested display pages, made up of path values and key & value parameter pairs. The received requests and path values and key & value parameter pairs may be stored if necessary and are passed on to control logic 420 for further processing.

Control logic 420 operates to receive a display page request from a user, predict ads of potential interest to a user, retrieve those ads, retrieve the requested display pages, impress the ads on the retrieved display pages, and send the display pages with the ads to the user. The display page requests are received from input block 410. Control logic 420 operates in conjunction with predictor block 430 to recommend ads that may be of potential interest to the user requesting the display pages. Control logic 420 requests and receives the recommended ads from ad server 170. Control logic 420 retrieves the display pages requested by the user from display page storage 450. Control logic 420 impresses the received ads on the retrieved display pages. Control logic 410 operates in conjunction with output block 460 to send the display pages (with the recommended ads) to the user. Further, control logic 420 operates in conjunction with recursion block 440 to update the tag universe recursively, as described in earlier paragraphs.

Predictor block 430 receives the URL of the requested display page from control logic 420. From the URL, predictor block 430 generates a request vector, matches the request vector to a row in the CTR matrix, selects ad vectors from the matched row, retrieves their CTR values, computes the ad score for the selected ad vectors as described above, and chooses the ads to be impressed, as described in earlier paragraphs. The chosen ad vector(s) are passed on to control logic 420.

Recursion block 440 receives the URL of the requested display page from control logic 420 extracts term sets as described above and re computes the overall score, updates the tag universe and re generates the CTR matrix from the updated tag universe, as described above.

Display page storage 450 stores display pages and acts co operatively with control logic 410 to retrieve and provide display pages to a user. The display pages may be stored in a storage medium such as a hard disk drive, in a well known manner.

Output block 460 operates in conjunction with Control logic 410 to send the message with display pages (with the recommended ads) to the user over path 465.

Though described in specific Figures/flowcharts merely for illustration, it should be appreciated that the individual features described above may be combined in different embodiments as suited for the corresponding environments. Such combinations are contemplated to be covered by various features of the present invention.

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed as being new and desired to be protected by Letters Patent of the United States is as follows:

1. A method of recommending and presenting advertisements (ads) with display pages over networks of communication devices and computers, said method comprising the steps of:
receiving a display page request from a user to at least one web server;
creating a request vector comprising a set of terms extracted from a URL of said display page request as well as terms from other information associated with said display page request;
matching said request vector to a row in a Click Through Rate (CTR) matrix using at least one ad server;
selecting ad vectors from said matched row and retrieving the CTR of the selected ad vectors from said CTR matrix;
computing ad scores for said selected ad vectors;
choosing one or more ad vectors from said selected ad vectors; and
presenting to the user through said web server one or more ads from said ad server corresponding to said one or more chosen ad vectors along with the requested display pages.

2. The method of claim 1, wherein said matching is a broad matching.

3. The method of claim 2, wherein said broad matching is obtained through a dot product between the said request vector and a row index of the said CTR matrix.

4. The method of claim 1, wherein said selecting selects a predetermined number of ad vectors having the highest CTR values.

5. The method of claim 1, wherein said computing computes the ad score as a weighted average of the CTR value and factors comprising ad conversion rate, Cost Per Click (CPC), Cost Per Acquisition (CPA), ad budget and business rules.

6. The method of claim 1, wherein said choosing chooses one or more ad vectors having the highest ad score.

7. The method of claim 1, wherein said choosing chooses one or more ad vectors at random from a predetermined number of ad vectors having the highest ad score.

8. The method of claim 1, wherein said other information associated with the display page request comprises time of request, country, mobile network operator and hand set parameters.

9. The method of claim 1, wherein said CTR matrix is created by steps comprising of:
generating a page vector for all the display page requests;
retrieving all ad vectors corresponding to the said page vector;
computing the CTR value for the retrieved ad vectors;
inserting the computed values into the CTR matrix with page vectors as column index and ad vectors as row index;
estimating the CTR value for the elements of the CTR matrix with no value; and
storing the CTR matrix.

10. A web server process for recommending, retrieving and presenting ads of potential interest to a user along with display pages comprising:
an input block for receiving requests for display pages from users;
a predictor block for selecting one or more ad vectors from a CTR matrix, computing an ad score for the selected ad vectors and choosing one or more ad vectors from the selected ad vectors;
a recursion block to update the CTR matrix from the requests for display pages;
a display page storage for storing the display pages to be presented to users in response to the requests for display pages;
an output block to send the requested display pages with the chosen ads to the user; and
a control logic to operate in conjunction with said input block, said predictor block said recursion block, said display page storage and said output block to receive a display page request from a user, recommend and select ad vectors of potential interest to a user, choose one or more ad vectors from selected ad vectors, retrieve ads corresponding to said chosen ad vectors, retrieve the requested display pages, impress the ads on the retrieved display pages, and present the display pages with the ads to the user.

11. A machine readable medium carrying one or more sequences of instructions for causing a system to recommend and present advertisements (ads) with display pages over networks of communication devices and computers, wherein execution of said one or more sequence of instructions by one or more processors contained in said system causes said system to perform the actions of:
receiving a display page request from a user to at least one web server;
creating a request vector comprising a set of terms extracted from a URL of said display page request as well as terms from other information associated with said display page request;
matching said request vector to a row in a Click Through Rate (CTR) matrix using at least one ad server;
selecting ad vectors from said matched row and retrieving the CTR of the selected ad vectors from said CTR matrix;
computing ad scores for said selected ad vectors;
choosing one or more ad vectors from said selected ad vectors; and
presenting to the user through said web server one or more ads from said ad server corresponding to said one or more chosen ad vectors along with the requested display pages.

12. The machine readable medium of claim 11, wherein said matching is a broad matching.

13. The machine readable medium of claim 12, wherein said broad matching is obtained through a dot product between the said request vector and a row index of the said CTR matrix.

14. The machine readable medium of claim 11, wherein said selecting selects a pre determined number of ad vectors having the highest CTR values.

15. The machine readable medium of claim 11, wherein said computing computes the ad score as a weighted average of the CTR value and factors comprising ad conversion rate, Cost Per Click (CPC), Cost Per Acquisition (CPA), ad budget and business rules.

16. The machine readable medium of claim 11, wherein said choosing chooses one or more ad vectors having the highest ad score.

17. The machine readable medium of claim 11, wherein said choosing chooses one or more ad vectors at random from a predetermined number of ad vectors having the highest ad score.

18. The machine readable medium of claim 11, wherein said other information associated with the display page request comprises time of request, country, mobile network operator and hand set parameters.

19. The machine readable medium of claim 11, wherein said CTR matrix is created by steps comprising of:
generating a page vector for all the display page requests;
retrieving all ad vectors corresponding to the said page vector;
computing the CTR value for the retrieved ad vectors;
inserting the computed values into the CTR matrix with page vectors as column index and ad vectors as row index;
estimating the CTR value for the elements of the CTR matrix with no value; and
storing the CTR matrix.
